(19) United States
(12) Patent Application Publication
(10) Pub. No.: US 2024/0199374 A1
(43) Pub. Date: Jun. 20, 2024

(54) MAINTENANCE OF ELEVATOR SYSTEM

(71) Applicant: KONE Corporation, Helsinki (FI)

(72) Inventor: Gabriela ROIVAINEN, Helsinki (FI)

(73) Assignee: KONE Corporation, Helsinki (FI)

(21) Appl. No.: 18/595,824

(22) Filed: Mar. 5, 2024

Related U.S. Application Data
(63) Continuation of application No. PCT/EP2021/079158, filed on Oct. 21, 2021.

(51) Int. Cl. B66B 5/00; G06N 20/00

(52) U.S. Cl. CPC B66B 5/0025; G06N 20/00

(57) ABSTRACT

In a solution for generating a machine learning model for evaluating a condition of an elevator, synthetic data descriptive of an operation of the elevator is generated; history data is generated; the synthetic data and the history data area compared; data descriptive of differences between the synthetic data and the history data is generate; a simulation model of the elevator is calibrated based on the data descriptive of the differences; calibrated synthetic data descriptive of at least one malfunction of the elevator is generated; and the machine learning model is trained with a training dataset based on the calibrated synthetic data to generate the machine learning model for evaluating a condition of the elevator.

### TECHNICAL FIELD

The invention concerns in general the technical field of elevator systems. More particularly, the invention concerns a maintenance of the elevator systems.

### BACKGROUND

Maintenance and repairing are crucial operations in order to safeguard a continuous operation of elevator systems. Due to this, approaches to detect an instant of time for the maintenance are introduced. For example, one approach applied in the maintenance is based on an idea where measurement data is gathered from the elevator systems and by applying predictive methods to the measurement data it has been possible to evaluate a need for the maintenance. In other words, a decision-making is based on data from which it may e.g. be derived how long a certain component under monitoring based on the history data operates properly and the maintenance work is scheduled accordingly.

The known approaches are operable as such, but their accuracy is not always at a desired level. This, in turn, increases the maintenance costs in a form that maintenance operations are conducted without a real need because the history data, or statistical data, does not necessary reflect a real state of the elevator system, or especially a component therein.

On the other hand, machine learning based approaches are more and more applied in varied application areas and their applicability in the maintenance related operations is proved.

Hence, novel approaches for applying machine learning in a maintenance of elevators, and, especially, in evaluating a condition of an elevator may be developed so as to maintain the elevator in optimized manner.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a computer-implemented method, a computing system, and a computer program for generating a machine learning model for evaluating a condition of an elevator. Another object is to present a method and an elevator for applying the generated machine learning model.

The objects of the invention are reached by a computer-implemented method, a computing system, a computer program, a method, and an elevator as defined by the respective independent claims.

According to a first aspect, a computer-implemented method for generating a machine learning model for evaluating a condition of an elevator is provided, the method comprising:
generating synthetic data descriptive of an operation of the elevator by simulating the operation of the elevator with a simulation model of the elevator;
accessing history data generated by operating the elevator corresponding to the elevator of the simulation model;
comparing the synthetic data with the history data;
generating data descriptive of differences between the synthetic data and the history data;
calibrating the simulation model of the elevator based on the data descriptive of the differences;
generating calibrated synthetic data descriptive of at least one malfunction of the elevator with a calibrated simulation model of the elevator;
training the machine learning model with a training dataset based on the calibrated synthetic data to generate the machine learning model for evaluating a condition of the elevator.

The simulation model of the elevator may e.g. be established by using a number of elevator specific parameters of the elevator for which the machine learning model is generated.

The simulation model may e.g. be an object-oriented dynamic model.

Further, the history data may be accessed by at least one of: obtaining a number of parameters of the elevator with a number of sensors; obtaining data of a control signal of an entity of the elevator; retrieving stored history data from data storage. The number of parameters of the elevator may be obtained from at least one of: at least one accelerometer associated to an elevator car; a motor encoder of an elevator door. For example, the control signal may be an input current of a door motor.

A calibration of the simulation model of the elevator may be performed by adjusting at least one definition of the simulation model of the elevator with information derivable from the history data.

On the other hand, the calibrated synthetic data descriptive of at least one malfunction of the elevator may be generated by:
determining a number of malfunctions typical to the elevator,
simulating the determined number of malfunctions with the simulation model of the elevator.

For example, the number of malfunctions typical to the elevator may be determined based on at least one of the following: maintenance requests of the elevator, maintenance operations performed to the elevator, troubleshooting reports of the elevator, error signals received from the elevator.

The training dataset may be generated from the calibrated synthetic data descriptive of at least one malfunction of the elevator by generating a number of representations of a predefined type. For example, the predefined type of representations may be expressed in at least one of: frequency domain, time domain.

The machine learning model under generation for evaluating the condition of the elevator may be a convolutional neural network, CNN.

According to a second aspect, a method for evaluating a condition of an elevator is provided, the method comprises:
receiving input data from the elevator under evaluation,
inputting the input data to a machine learning model generated according to the first aspect as described above, and
setting, in accordance with an output of the machine learning model, a detection result to indicate one of the following: (i) the elevator operates properly, (ii) the elevator malfunctions.

The input data may e.g. be obtained by obtaining at least one parameter indicative of an operation of the elevator.

Moreover, the detection result indicating that the elevator operates properly may further comprise data indicative of an expected lifetime of the elevator.

According to a third aspect, a computing system is provided, the computing system is configured to:
generate synthetic data descriptive of an operation of the elevator by simulating the operation of the elevator with a simulation model of the elevator;
access history data generated by operating the elevator corresponding to the elevator of the simulation model;
compare the synthetic data with the history data;
generate data descriptive of differences between the synthetic data and the history data;
calibrate the simulation model of the elevator based on the data descriptive of the differences;
generate calibrated synthetic data descriptive of at least one malfunction of the elevator with a calibrated simulation model of the elevator;
train the machine learning model with a training dataset based on the calibrated synthetic data to generate the machine learning model for evaluating a condition of the elevator.

The computing system may be configured to establish the simulation model of the elevator by using a number of elevator specific parameters of the elevator for which the machine learning model is generated.

The computing system may e.g. be configured to establish an object-oriented dynamic model as the simulation model.

Further, the computing system may be configured to generate the history data by at least one of: obtaining a number of parameters of the elevator with a number of sensors; obtaining data of a control signal of an entity of the elevator; retrieving stored history data from data storage. The computing system may be configured to obtain the number of parameters of the elevator from at least one of: at least one accelerometer associated to an elevator car; a motor encoder of an elevator door. For example, the computing system may be configured to apply an input current of a door motor as the control signal.

The computing system may be configured to perform a calibration of the simulation model of the elevator by adjusting at least one definition of the simulation model of the elevator with information derivable from the history data.

On the other hand, the computing system may be configured to generate the calibrated synthetic data descriptive of at least one malfunction of the elevator by:
determining a number of malfunctions typical to the elevator,
simulating the determined number of malfunctions with the simulation model of the elevator.

For example, the computing system may be configured to determine the number of malfunctions typical to the elevator based on at least one of the following: maintenance requests of the elevator, maintenance operations performed to the elevator, troubleshooting reports of the elevator, error signals received from the elevator.

The training dataset may be generated from the calibrated synthetic data descriptive of at least one malfunction of the elevator by generating a number of representations of a predefined type. For example, the computing system may be configured to generate the representations by applying in at least one of: frequency domain, time domain as the predefined type.

The computing system may be configured to generate a convolutional neural network, CNN as the machine learning model for evaluating the condition of the elevator.

According to a fourth aspect, an elevator is provided, the elevator comprising a computing system for executing a machine learning model generated according to the first aspect as defined above for evaluating a condition of the elevator.

According to a fifth aspect, a computer program is provided, the computer program comprising instructions which, when the program is executed by a computer, cause the computer to carry out the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a generation of a machine learning model as a flow chart according to an example.

FIG. 2 illustrates schematically a method according an example.

FIG. 3 illustrates schematically a computing system according to an example.

FIG. 4 illustrates schematically a computing system according to another example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

At least some aspects of the present invention may relate to a generation of a machine learning model by training it to evaluate a condition of an elevator. In accordance with the present invention the training may be performed in an efficient manner so that the machine learning model may be used in maintenance operations with elevators.

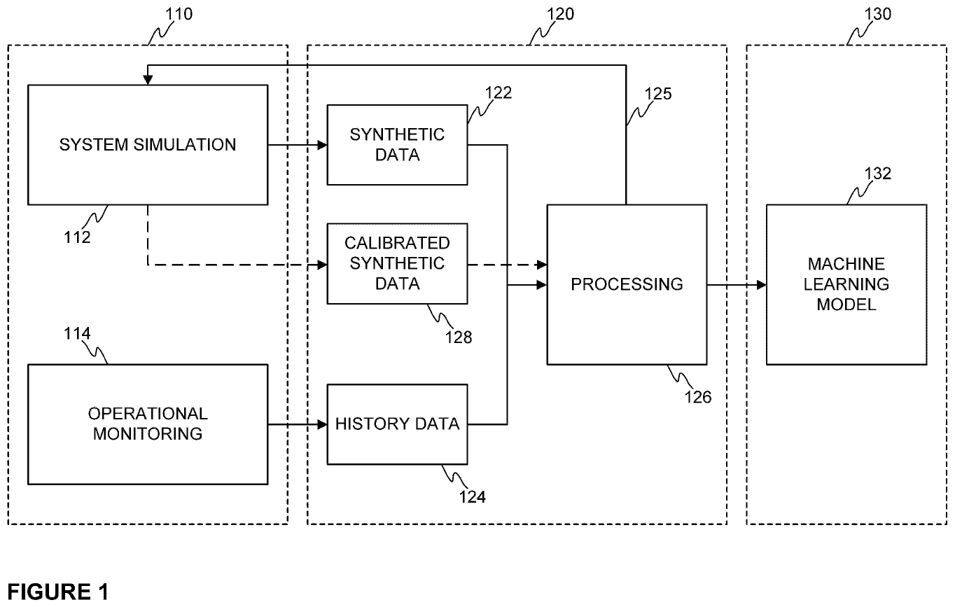

FIG. 1 illustrates schematically, as a structural model, at least some aspects of a system of training a machine learning model for evaluating a condition of an elevator. The structural model schematically illustrated in FIG. 1 is indicated to consist of three sections: an input section 110, a training section 120, and an output section 130.

The input section 110 illustrates schematically items used for generating data input to the machine learning model to train it for use. First item is a system simulation 112 in which an elevator system is simulated with computer-implemented methods to generate synthetic data 122 input to the training section 120. A second item in the input section is an operational monitoring 114 in which data is generated by a real elevator system. The data generated by the operational monitoring 114 is input to the training section 120 as a history data 124.

More specifically, the system simulation 112 refers to a simulation in which the entity under simulation, i.e. the elevator, is described, or defined, with a predefined accuracy, such as at a component and operational level with a set of parameters, in a simulation model wherein a simulation software is configured to imitate a real operation of the elevator. The description of the elevator may define an architecture of the elevator at a component level, or as a bill of materials, wherein the components, and respective elements, may be simulated at their level, but also at a so-called multibody simulation level wherein a plurality of components, or entities, are combined at a meaningful accuracy and the multibody element is simulated. Additionally, the simulation model may take operational data, such as algorithms defining an operation of a number of entities of the elevator like motor and motion control algorithms, as an input. The above-mentioned items enable a computation of predefined physical parameters, such as stiffness, damping, friction, current and so on, for individual components and/or for multibodies, like for elevator drive, motor, bedplate, ropes, guide rails, guide shoes, sling, car, doors buffers, etc. In addition, in some implementations the simulation may comprise a step in which physical parameters of at least some components may be measured e.g. with applicable testing devices. In accordance with an example the simulation may be performed so that a master file is compiled based on the physical computing parameters and measured physical parameters defined for individual components. The master file may be used for configuring a simulation model of the elevator. In order to do this, the generated simulation model of the elevator is operated by simulating a normal operation of an elevator in question. This may include, but is not limited to, a running of the elevator from one floor to another in a space the elevator is operating or planned to be operating. In any case, the model of the elevator is run in conditions wherein the elevator is concluded to operate in a normal manner.

In addition, the simulation model may be operated by simulating the elevator operation in faulty conditions. In other words, the operation of the elevator is simulated so that there is set one or more features of the elevator in a faulty manner. For example, it may be set that the guide rails are misaligned over an acceptable limit, or that the motor receives a high excitation current e.g. due to errors in stator slot geometry. Further non-limiting examples of setting the misbehaviour may comprise a mis-selection of one or more components (e.g. so that the ropes are set too flexible, guide shoes are caused to run on stoppers, the components are set to be worn to some extent, and so on). Additionally, the simulation model of the elevator may be run to execute performance tests, which are defined to execute certain predefined operations, like car sag and bouncing, buffer run, emergency stop and so on.

The establishment of the simulation model and the simulation of the operation of the elevator with the simulation model in a variety of conditions, and situations, enables a generation of a synthetic data representative of the elevator at system level wherein the elevator and its components are described with a set of parameters derived in the manner as described. The synthetic data is advantageously formed with the model so that the parameters descriptive of the elevator and its operation are such that they are comparable either directly or indirectly to data measurable from the real elevator system to make them comparable. For example, parameters may be motion related parameters, such as car displacement, velocity, acceleration, but also other physical parameters, e.g. indicative on guide shoe forces, motor rotation, and so on. As is clear from above the modelling is advantageously performed with time-dependent variable parameters to generate the synthetic data descriptive of the elevator, and its operation, in various situations.

As a non-limiting example of the simulation model an object-oriented dynamic model may be mentioned as advantageous in the context of the present invention since it is fast to use in the described application area and does not require that heavy computing systems. Naturally other simulation models, such as finite element simulation models, may be applied to even if they are not that efficient in view of the need and speed of modelling in the context of elevator systems. Especially, such other simulation models may advantageously be applied for determining certain variable parameters, such as masses, stiffness, damping, etc., which then are input in the object-oriented dynamic model.

In the foregoing description a creation of the simulation model is performed by inputting certain parameters defining the elevator system in a required accuracy to a computing system configured to perform the simulation of the system as described. In some example embodiments the simulation of the elevator system may be arranged so that the computing system configured to perform the system simulation may prompt a user to input an identifier of an elevator system to be simulated. The elevator identifier may unambiguously define the elevator system and in response to inputting the elevator system identifier to an application executed by the computing system a data record defining the elevator system setup, such as bill of materials and any other data, may be inquired from data storage configured to store the definitions of the elevator system. In such a manner a general simulation model may be modified to correspond to the elevator system to which the machine learning model is to be established. For sake of clarity, it is worthwhile to mention that the data storage may refer to an internal memory of the computing system or to an external entity configured to store such data and that is communicatively connected to the computing system configured to perform the simulation.

As already mentioned, the other data item to be used for enabling the training of the machine learning model is the history data 124 generated through the operational monitoring referred with 114 in FIG. 1. The operational monitoring 114 is performed by monitoring predefined features of the elevator by obtaining data indicative of the monitored feature. The monitoring may be performed by obtaining measurement data from the system during a normal operation of the elevator or by controlling the elevator in question to conduct a variety of operations, such as normal drives from one floor to another, but also causing specific situation, such as emergency stops and similar. For example, a number of sensors, such as accelerometers, may be positioned to the elevator, such as to the elevator car, in order to gather measurement data indicative of a monitored aspect of the elevator car. In the context of elevator cars under evaluation the measured aspect may be a vibration experienced by the elevator car, for example. In some implementations the monitored entity may be elevator doors and their motion and/or force in the elevator system.

The sensors in question may be integrated to the elevator system or positioned in a device setup e.g. on a roof of an elevator car to obtain the measurement data. The measurement data is delivered to a computing entity over a predefined communication channel which may be either wireless or the delivery may be implemented in a wired manner.

The operational data is obtained in the described manner from an elevator system corresponding to one modelled with the simulation model and used for generating the synthetic data so as to make the pieces of data comparable to each other.

For sake of completeness, the history data may be generated through the operational monitoring so that the computing system have enough data to generate a representation of the operation of the elevator and any specific aspects therein. In order to achieve this the generation of the history data may be performed over a predefined period of time or it may be performed so that the same operational features are repeated a predefined number of times.

It is also worthwhile to mention that accessing the history data by the computing system may also cover an approach in which computing system inquires, or retrieves, the history data from data storage into which such data is stored based on a monitoring of the operation of the elevator and/or entities therein. This kind of approach may thus be an alternative or an addition to the other described approaches, such that obtaining a number of parameters of the elevator with a number of sensors as descriptive of the history data and/or that data of a control signal of an entity of the elevator is obtained.

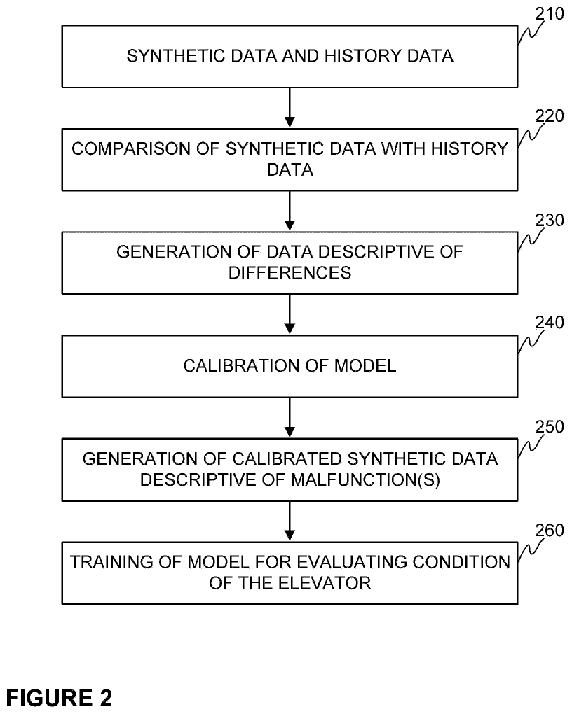

The training section 120 of FIG. 1 schematically illustrates a phase in which a machine learning model is generated for performing a task of evaluating a condition of an elevator as described. FIG. 2 illustrates schematically a method according to an example of the present invention disclosing steps of generating the model wherein an implementation of the method is referred with the box of processing 126 in FIG. 1. The method may be performed by the computing system configured to generate 210 the synthetic data 122 and to access the generated history data 124 in the manner as described. In order to generate the model the computing system may first be arranged to compare 220 the synthetic data 122 with the history data 124 and to detect differences, if any, between the data sets. In order to perform the comparison the compared pieces of data of the synthetic data and the history data are arranged such that they are comparable to each other with a desired accuracy. The accuracy of the capability to detect the differences may be defined in accordance with requirements. In any case, the comparison may reveal differences in physical parameters between the model and the real implementation of the elevator, which may e.g. be due to installation accuracy or component related inaccuracies. Alternatively, the differences may be related to operational parameters described in terms of time, position, force, etc. The comparison may also bring out unknown features which are not derivable or known through the simulation. Some non-limiting examples of such features may be misalignments in the installation of guide rails or damping of components. In response to a detection of the deviations between the real measured data and the synthetic data, as well as the detection of unknown or uncertain parameters or features, the computing system may be configured to generate feedback data descriptive of differences between the synthetic data 122 and the history data 124 and to input that as a feedback signal (arrow referred with 125 in FIG. 1) to modify the simulation model of the elevator based on the data descriptive of the differences. Specifically, this may correspond to an operation in which one or more parameters of the model, or applied in the model, are detected to differ from the respective parameters of the real implementation, or operation, of the elevator, the parameters applied in the model are adjusted to corresponding ones of the real implementation of the elevator. In other words, the simulation model may be calibrated 240 based on the descriptive of the differences in order to achieve the calibrated object-oriented model to imitate the real elevator system in question in a better way.

In response to the step of calibrating 240 the object-oriented model with the data descriptive of the differences the computing system is arranged to generate 250 calibrated synthetic data 128 for malfunction by simulating the elevator system with the calibrated simulation model of the elevator. In other words, the computing system is configured to simulate a predetermined number of malfunctions of predefined types to generate calibrated synthetic data descriptive of at least one malfunction of the elevator. The malfunctions simulated with the calibrated simulation model may be selected in a predefined manner. In accordance with an example embodiment the types of malfunctions to be simulated may be selected on a basis of data descriptive of malfunctions occurred in the elevator in question, or e.g. in a plurality of elevators being the same type as the elevator in question for which the machine learning model to evaluate a condition of the elevator is generated. Such data descriptive of malfunctions may be established with a feedback mechanism in which any maintenance request or maintenance operation, any troubleshooting report, or any error signal from the elevator, or from the plurality of elevators e.g. of the same type, is analysed so that the type(s) of malfunction(s) is/are identifiable, and the generated calibrated simulation model is adjusted to execute corresponding malfunctions. For example, the adjustment of the simulation model may be arranged so that the input data of the model, such as a structure of elevator or component values or any other input value, is adjusted so that it causes at least one identified malfunction. Such an approach requires deep understanding of an operation of the elevator system as well as understanding of causalities in the elevator system and may be defined as an automatic function in the simulation software e.g. so that the received malfunction data is analysed and involved entities to the malfunction are identified, and the elevator model is changed according to predefined rules so that a root cause for the respective malfunction is present in the model. As non-limiting examples it may be mentioned that e.g. a 1 mm flat spot of guide shoes may be modelled as a 1 mm excitation of model with the rotational frequency of guide shoes or that an irregular guide rail oiling may be modelled as a variable friction coefficient between sliding guide shoes and guide rails for the section where there is oil and where there is not oil. In response to that the adjustments to the model are introduced in accordance with the identified malfunctions the calibrated simulation model is run to generate calibrated synthetic data descriptive of one or more malfunctions of the elevator. An advantage of the approach as described is that the generation of the calibrated synthetic data descriptive of the at least malfunction labels the malfunctions at the same time which means that the data is arranged to comprise an identifier, or to label, defining the type of malfunction described with the calibrated synthetic data in question

In response to the generation 250 of the calibrated synthetic data 128 descriptive of at least one malfunction of the elevator it may be used for training the machine learning model 315 in a manner as described in the forthcoming description. Depending on an implementation of the invention the calibrated synthetic data 128 may be prepared for the training purpose so that the training may be performed in an efficient way. In accordance with an example embodiment, the calibrated synthetic data may be input to the processing 126 phase executed by the computing system to generate applicable representations from the calibrated synthetic data 128 of malfunctions which representations are descriptive of the malfunctions and suitable to be input to the machine learning model for training. The term representation may herein refer to an image representation in a predefined domain as is described in the forthcoming description. The generation of the representations may be performed by inputting the calibrated synthetic data of the number of malfunctions to a computing system executing a software configured to transform the calibrated synthetic data descriptive of the malfunctions to a predefined type of representations. For example, the computing system, and the software in question, may be configured to transform the calibrated synthetic data describing the malfunctions to a representation in a frequency domain or to a representation in a time domain wherein the representation may be expressed in 2-dimensional format or in 3-dimensional format. Depending on the type of malfunctions, and the entity experiencing the malfunctions in question, the representation may be spectrograms, cepstrums, or graphs. The spectrograms and the cepstrums are representations in a frequency domain describing specific signal characteristic. For example, the spectrogram may be a 3-dimensional representation of the frequency content of the car vibrations, for the entire length of the elevator travel. The 3-dimensions may be frequency, amplitude, and travel position. These spectrograms may be obtained by doing a Fast Fourier Transformation (FFT) of the unallowable car vibrational signal, for the time domain where the elevator maintains a constant speed. In other words, the car vibrations descriptive of malfunctions may e.g. be simulated in in three directions: vertically, from the elevator door to back of the car and from one guide rail to another. For each direction, a specific spectrogram may be generated descriptive of the malfunction to the direction in question. It may also be arranged that by doing the FFT for a short time window, the representation is a 2-dimensional diagram, or graph, in which amplitudes of frequencies are plotted versus values of frequencies. In case the cepstrums are used as the format of representation an inverse Fourier Transform is computed to the source data i.e. the calibrated synthetic data 128 descriptive of the malfunction or malfunctions to generate the cepstrums. As mentioned for some type of malfunctions a graph in time domain may be suitable for the purpose of the present invention, wherein such a graph may express a variable signal amplitude of the simulated parameter in time, for example.

For sake of completeness, it is worthwhile to mention that in some example embodiments in the step referred with 250 calibrated synthetic data may be generated with the calibrated simulation model which is descriptive of a normal operation, and setup, of the elevator, or a respective entity under evaluation. As a result, respective representation may also be generated from that data. Such information may be used in the estimation of the condition of the elevator e.g. to estimate a degree of a malfunction of the elevator.

The purpose of the step of generating the calibrated synthetic data, and the number of representations of a predefined type at least in some implementations, may be summarised so that the generated representations form together so-called training dataset for a neural network to configure the neural network to perform the task of evaluating a condition of an elevator. The training data, such as the representations generated in the described manner, are extremely suitable for training the neural network since the training data is labelled with the described method for the training.

Now, the generated training data, such as the calibrated synthetic data or any derivation from it, descriptive of the malfunctioning may be used for training 260 a neural network to evaluate the condition of the elevator. The trained neural network is advantageously a type of a convolutional neural network (CNN) which consists of an input layer, hidden layers, and an output layer. However, other types of neural networks may also be applied to in the context of the present invention. The applied CNN may be arranged to conform with inception architecture and the network may be fine-tuned by increasing weight learn rate and bias learn rate from the latest convolutional layers and a fully connected layer. This increases efficiency in training and using the CNN. The training of the respective neural network is performed through a training the neural network with the labelled training dataset so that the neural network learns classifying any input data to one of classes definable with the training dataset. For example, a type of malfunction defined by one or more labelled training dataset teach the neural network to use certain criteria if input data shall be classified to the class defined by the one or more labelled training datasets. Depending on the training dataset, and their source data, the training for the classification task may be performed in a supervised manner or unsupervised manner. In other words, as a result of the training the neural network has defined parameters (also referred to as “weights”) by means of which the loss of the algorithm will be minimized (optimization) and, through the optimization of the algorithm, the neural network is operative in its task to evaluate the condition of an elevator, and eventually to detect the need for the maintenance. For example, the generated neural network may be arranged to analyse the history data and any new measured data and to detect if the analysed data comprise any indications on a need for a maintenance. For example, the trained neural network may be generated so that the evaluation of the condition of the elevator is performed based on data indicative of vibrations, or any other selected parameter(s), experienced by a monitored entity of the elevator, such as by the elevator car.

All in all, the trained machine learning model, i.e. the trained neural network, is configured to evaluate a condition of the elevator by receiving input data and to classify the data in accordance with its parameters derivable from the input data. Through the classification the machine learning model may provide an output that the input data is indicative of a certain type of malfunction based on the class the input data is judged to belong to. For sake of clarity it is worthwhile to mention that certain class may be one indicative of that the elevator system operates properly, since the input data was not classified to any other class indicative of respective malfunctions.

Next a more specific example of generating the machine learning model is provided with respect to a specific entity of the elevator system. The specific entity may be elevator doors which typically comprises both the elevator car door and the landing door taken into account in the generation of the model, but in some implementation only one of these doors used for the purpose of the present invention. Hence, the aim is to generate a machine learning model suitable for evaluating a condition of an elevator door. In the solution for elevator doors the synthetic data 122 may be generated by creating simulation models representing the elevator door with information on the components of the door and any multibodies therein as well as any algorithms applied in controlling an operation of the door together with CAD design of the doors. Additionally, physical parameters of the door related components may be measured in an appropriate manner. Based on the simulation of the components and multibodies as well as using the applied algorithms in the simulation together with the information on the physical parameters of the respective components, or at least part of them, a simulation model of the elevator door may be compiled. Then the compiled simulation model is run in a various situation of the elevator door. For example, the simulation with the simulation model may be performed for normal operation of the respective door e.g. over a full operating cycle. Further, faulty operation of the door may be arranged with the simulation, such as arranging a misalignment of lock rollers, arranging a jamming of a door coupler, or arranging smaller lock clearance issues, and so on. Additionally, the model may be arranged to simulate a performance test to the respective elevator door. The synthetic data 122 generated with the simulation may advantageously be expressed with parameters measurable from the elevator doors of an elevator in use which parameters may e.g. be door control panel current, door position, and a velocity e.g. with respect to a reference velocity.

As it comes to the history data 124 it may be generated by monitoring and measuring a predetermined parameter of an elevator door corresponding to one for which the synthetic data is generated in a real elevator system. In accordance with an example the predetermined parameter may be a control signal, and its value, of an entity related to the elevator door, wherein the data of the control signal may e.g. be input current of a door motor. On the other hand, data indicative of the operation of the elevator door may be obtained from an applicable entity, such as from a motor encoder of the elevator door, but it is also possible to obtain velocity data e.g. with respect to a reference velocity determined with an applicable sensor setup from the door operation. Here, the door operation from which at least some pieces of the history data may be collected from may represent various situations occurring with the elevator door e.g. in normal operation as well as in specific situations and in performance tests.

As a result of above-described operations the computing system possesses synthetic data 122 and history data 124 and the computing system is configured to compare 220 the synthetic data 122 with the history data 124. In response to the comparison, it may be detected differences as well as information on any unknown or uncertain parameters and such pieces of information may be provided as a feedback to the original simulation model so as to modify the object-oriented model accordingly to represent more accurately the door setup for which the machine learning model is under generation. As a result, the calibrated simulation model is arranged to generate calibrated synthetic data for a number of predefined types of malfunctions. The types of malfunctions may be selected in accordance with an information descriptive of malfunctions occurring to the elevator door, or elevator door type, in question. Such information may correspond to information on maintenance requests or maintenance operations, troubleshooting reports, or any error signals received from the system descriptive of the malfunctions of the elevator door. Consequently, the calibrated simulation model, such as an object-oriented dynamic model, may be configured to generate calibrated synthetic data 128 of the predefined types of malfunctions.

Now, the computing system possesses the calibrated synthetic data 128 descriptive of malfunctions of the elevator doors and the computing system may be configured to use that data for training the machine learning model to the task of evaluating a condition of the elevator, i.e. the elevator doors. Depending on the implementation, the calibrated synthetic data may be manipulated in a selected manner to be more suitable for the training which may, for example, refer to an operation to perform a transformation of the calibrated synthetic data to a representation of a predefined type. For example, in the context of the elevator doors the representations may be one or more graphs generated from a simulated signal expressing a door force versus to door movement in various malfunction situations. The generated images through the transformation form so-called training dataset for a neural network in order to cause it to perform a task of evaluating the condition of the elevator door.

Next, a neural network being e.g. a type of a convolutional neural network (CNN) is trained with the generated training dataset. The training is performed by arranging the neural network to learn to classify input data to a class from a number of classes defined by the data in the training dataset so as to have a classification model to be applied with real data obtainable from a real elevator door arrangement.

The trained neural network may then be taken into use for detecting misbehaviour, and malfunctioning, of the elevator door so that measurement data matching with the data used in the training of the neural network is obtained and generated from the elevator door and input, by transforming it to applied type of representation, to the neural network for detecting if it indicates malfunctioning.

To summarize the outcome of the method and the outcome of the training it may be concluded that the method generates a computer program which is configured to detect, by applying trained rules to the input data e.g. obtained by measuring predefined parameters of the monitored entity, if the elevator operates within acceptable limits or not. In other words, the computer program generated in the described manner may be stored, in response to the generation, to data storage, such as to an internal memory of an entity of the computing system or to another memory by generating a communication connection from the computing system to the respective entity comprising the memory. The generated computer program may also be set available for downloading to other entities, such as to the computing system selected to implement a monitoring of the elevator for evaluating a condition of it. As a result, the computer program may be installed to the respective computing system and executed therein so that it continuously receives the input data from the monitored elevator, and/or any entity therein, and the machine learning model executed by running the computer program is arranged to perform the evaluation of the condition of the elevator.

Hence, the respective computing system configured to execute the generated computer program is configured to perform a method for evaluating a condition of an elevator 440, wherein the computing system is arranged to receive input data from the elevator 440 under evaluation, wherein the input data may be obtained by obtaining at least one parameter indicative of an operation of the elevator 440. This refers to a receipt of data from an entity of the elevator 440, such as from sensors detecting vibration or from elevator door related monitoring system, which data is such that it conforms with the training of the machine learning model, i.e. that the machine learning model generated in the manner as described herein, may perform its task to evaluate the condition of the elevator. In response to the output of the machine learning model the method may comprise a step of setting a detection result to indicate at least one of the following: (i) the elevator 440 operates properly, (ii) the elevator 440 malfunctions. In some example embodiments, a further outcome of the method, especially when the detection result indicates that the elevator 440 operates properly, may be that it provides further information, such as information on an expected lifetime of the monitored entity of the elevator 440. This, in turn, helps in planning a schedule of maintenance to the elevator in question 440. Such an implementation may e.g. be arranged so that the calibrated synthetic data is arranged to be generated with such a resolution that the machine learning model may be trained with such an accuracy that it may provide estimations of the lifetime of the entity under evaluation. For example, in such a case at least part of the generated calibrated synthetic data may be such that it is considered to represent malfunctioning, but within acceptable limits, and the detection result is decided to indicate that the elevator operates properly. The training itself may be arranged by labelling the generated calibrated synthetic data in accordance with the selected resolution and to arrange the data to comprise definitions for the expected lifetime of the respective entity.

Referring to above at least some aspects of the present invention relate to an elevator comprising a computing system for executing a machine learning model 315 generated in a form of the computer program as described for evaluating a condition of the elevator 440.

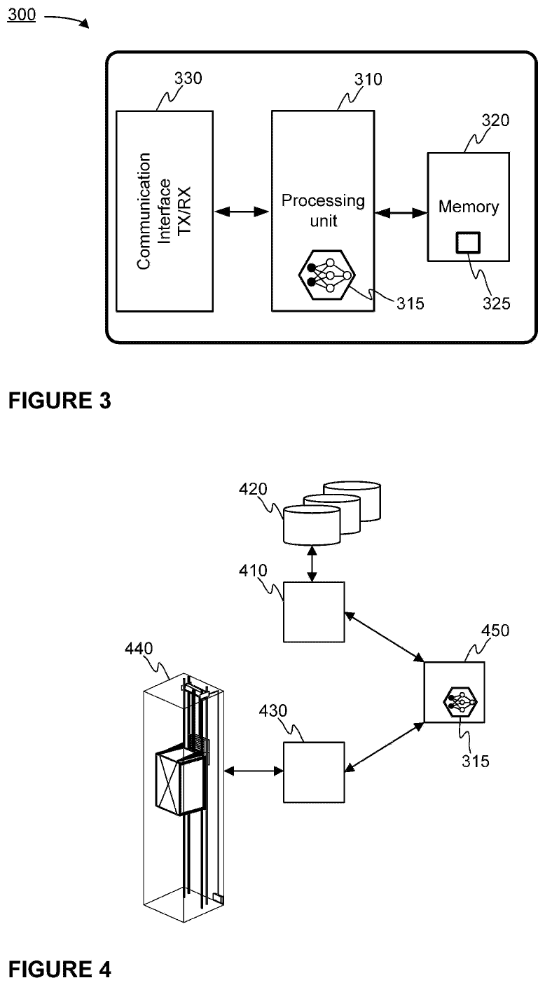

An example of an apparatus suitable for performing a method according to an example embodiment of the invention as the computing system 300 is schematically illustrated in FIG. 3 as a block diagram. The apparatus may be configured to implement at least part of the method for creating a machine learning model for evaluate a condition of an elevator, or a component of the elevator, as described. The execution of the method, or at least some portions of it, may be achieved by arranging a processing unit 310 comprising at least one processor to execute at least some portion of computer program code 325 stored in at least one memory 320 causing the processor 310, and, thus, the apparatus to implement the method steps as described. In other words, the processing unit 310 may be arranged to access the memory 320 and to retrieve and to store any information therefrom and thereto. Moreover, the processing unit 310 may be configured to control a communication through one or more communication interfaces 330 for accessing the other entities being involved in the operation. Hence, the communication interface 330 may be arranged to implement, possibly under control of the processing unit 310, a number of communication protocols, such as an IP or any other communication protocol, for communicating with one or more entities to receive input and to output data as described. The term communication interface 330 shall be understood in a broad manner comprising necessary hardware and software elements for implementing the communication techniques. Further, the apparatus in question comprises one or more input/output devices for inputting and outputting information. In accordance with the present invention such input/output devices forming a user interface may at least comprise a touch screen, but may also comprise further entities, such as a physical keyboard, buttons, display, loudspeaker, microphone camera and so on. In some implementation of the apparatus at least some of the input/output devices may be external to the apparatus and coupled to it either wirelessly or in a wired manner. For sake of clarity, the processing unit 310 herein refers to any unit or a plurality of units suitable for processing information and control the operation of the apparatus in general at least in part, among other tasks. The mentioned operations may e.g. be implemented with a microcontroller solution with embedded software. Similarly, the invention is not limited to a certain type of memory 320, but any memory unit or a plurality of memory units suitable for storing the described pieces of information, such as portions of computer program code and/or parameters, may be applied in the context of the present invention. Moreover, at least the mentioned entities may be arranged to be at least communicatively coupled to each other with an internal data connection, such as with a data bus.

In FIG. 3 it is also schematically illustrated a machine learning model 315 executable with the main processing unit 310 or with a dedicated processing unit. The machine learning model 315 may be dedicated at least to perform an evaluation of a condition of an elevator as described in the foregoing description in response to that it is created in the manner according to a method. In other words, the operation of the detection may be based on so-called machine learning, such as on so-called deep learning. Deep learning may involve learning of multiple layers of nonlinear processing units, either in supervised or in unsupervised manner. These layers form a hierarchy of layers, which may be referred to as artificial neural network. Each learned layer extracts feature representations from the input data, where features from lower layers represent low-level semantics (i.e. more abstract concepts). Generally speaking, deep learning techniques allow for recognizing and detecting objects in images with great accuracy, outperforming previous methods.

Hence, the computing system 300 as schematically illustrated in FIG. 3 is configured to receive the synthetic data 122 and the history data 124 as inputs in the first phase, to process those in the manner as described in the foregoing description, and to provide feedback to the simulation model to cause a generation of calibrated synthetic data which data is then processed in the described manner and used, in the processed form, to train the machine learning model 315 so as to generate a model suitable of evaluating the condition of the elevator.

In some examples, the computing system 300 may be implemented with a distributed computing environment in which a plurality of computing devices is configured to cooperate to cause an execution of the method according to at least one of the examples as described. A non-limiting example of such a distributing computing system is disclosed in FIG. 4 in which a first computing unit 410 may be dedicated to performing a generation of the simulation model and a simulation of an elevator system with the simulation model therein. The first computing unit 410 may be communicatively connected to a number of databases 420 in order to inquire information with respect to the elevator system and any components therein as well as to store data therein. A second computing unit 430 may be communicatively connected to an elevator 440 for which the machine learning model is generated to evaluate a condition of the elevator 440, and/or any entity of the elevator 440. For example, the second computing unit 430 may be configured to receive measurement data from one or more sensors, such as from accelerometer(s), of the elevator 440. The second computing unit 430 may be configured to process the measured data in a predetermined manner, if any, and to deliver that to a third computing unit 450. The synthetic data generated by the first computing unit 410 may also be delivered to the third computing unit 450 so as to arrange the third computing unit 450 have access to pieces of data to perform the comparison 220 as well as to generate data descriptive of the differences to be delivered to the first computing unit 410 to calibrate the simulation model and to generate the calibrated synthetic data 128 by the first computing unit 410. As described the calibrated synthetic data 128 is then delivered to the third computing unit 450 so as to train a machine learning model 315 to a task of evaluating a condition of the elevator and/or any entity of the elevator 440.

As derivable from above, some aspects of the present invention may relate to a computer program product which, when executed by at least one processor, cause an apparatus as the computing system 300 to perform at least some portions of the method as described. For example, the computer program product may comprise at least one computer-readable non-transitory medium having the computer program code 325 stored thereon. The computer-readable non-transitory medium may comprise a memory device or a record medium such as a CD-ROM, a DVD, a Blu-ray disc, or another article of manufacture that tangibly embodies the computer program. As another example, the computer program may be provided as a signal configured to reliably transfer the computer program.

Still further, the computer program code 325 may comprise a proprietary application, such as computer program code for generating the machine learning model in the manner as described.

The computer program code 325 may also be considered to include the definitions and instructions of an execution of the machine learning model 315 as described herein in response to that the generated machine learning model is installed to a computing system configured to perform the evaluation of the condition of the elevator and/or any entity therein.

The approach according to the present invention is advantageous in a sense that it allows a generation of a training dataset from a synthetic data which, in turn, is generated with a simulation model accurately corresponding to the real elevator 440 for which the machine learning model for evaluating a condition of the elevator 440 and/or any entity of the elevator 440 is generated. Hence, the generated model is accurate for the evaluation of that specific elevator, and to predict a need for a maintenance of the elevator 440.

The computing system arranged to run the computer program generated in the described manner may e.g. correspond to one as illustrated in FIG. 3, but the execution of the computer program may also be arranged in the environment as schematically illustrated in FIG. 4.

For sake of clarity and completeness it is worthwhile to understand that in the description of the invention herein it is mainly referred to an evaluation of a condition of the elevator as the outmost goal of the invention. The term “elevator” in this context shall be understood to cover an evaluation of the overall condition of the elevator system based on evaluated object, but also that the term “elevator” is interpreted to mean a specific entity, or component, of the elevator system, such as the elevator door. The applied parameters and values to be measured shall be adjusted in accordance with the entity under evaluation, such as in case a vibration of the elevator car is used for evaluating the condition, measurement data may e.g. be obtained from one or more accelerometers associated to the elevator car. On the other hand, if the elevator doors are under monitoring, a parameter indicative of a door force, such as current data of the door motor, may be used as at least one parameter in the evaluation.

The specific examples provided in the description given above should not be construed as limiting the applicability and/or the interpretation of the appended claims. Lists and groups of examples provided in the description given above are not exhaustive unless otherwise explicitly stated.

1. A computer-implemented method for generating a machine learning model for evaluating a condition of an elevator, the method comprising:
generating synthetic data descriptive of an operation of the elevator by simulating the operation of the elevator with a simulation model of the elevator;
accessing history data generated by operating the elevator corresponding to the elevator of the simulation model;
comparing the synthetic data with the history data;
generating data descriptive of differences between the synthetic data and the history data;
calibrating the simulation model of the elevator based on the data descriptive of the differences;
generating calibrated synthetic data descriptive of at least one malfunction of the elevator with a calibrated simulation model of the elevator; and
training the machine learning model with a training dataset based on the calibrated synthetic data to generate the machine learning model for evaluating a condition of the elevator.

2. The computer-implemented method of claim 1, wherein the simulation model of the elevator is established by using a number of elevator specific parameters of the elevator for which the machine learning model is generated.

3. The computer-implemented method of claim 1, wherein the simulation model is an object-oriented dynamic model.

4. The computer-implemented method of claim 1, wherein the history data is accessed by at least one of: obtaining a number of parameters of the elevator with a number of sensors; obtaining data of a control signal of an entity of the elevator; retrieving stored history data from data storage.

5. The computer-implemented method of claim 4, wherein the number of parameters of the elevator is obtained from at least one of: at least one accelerometer associated to an elevator car; a motor encoder of an elevator door.

6. The computer-implemented method of claim 4, wherein the control signal is an input current of a door motor.

7. The computer-implemented method of claim 1, wherein a calibration of the simulation model of the elevator is performed by adjusting at least one definition of the simulation model of the elevator with information derivable from the history data.

8. The computer-implemented method of claim 1, wherein the calibrated synthetic data descriptive of at least one malfunction of the elevator is generated by:
determining a number of malfunctions typical to the elevator; and
simulating the determined number of malfunctions with the simulation model of the elevator.

9. The computer-implemented method of claim 8, wherein the number of malfunctions typical to the elevator is determined based on at least one of the following: maintenance requests of the elevator, maintenance operations performed to the elevator, troubleshooting reports of the elevator, error signals received from the elevator.

10. The computer-implemented method of claim 1, wherein the training dataset is generated from the calibrated synthetic data-descriptive of at least one malfunction of the elevator by generating a number of representations of a predefined type.

11. The computer-implemented method of claim 10, wherein the predefined type of representations is expressed in at least one of: frequency domain, time domain.

12. The computer-implemented method of claim 1, wherein the machine learning model under generation for evaluating the condition of the elevator is a convolutional neural network, CNN.

13. A method for evaluating a condition of an elevator, the method comprising:
receiving input data from the elevator under, evaluation;
inputting the input data to a machine learning model generated according to, claim 1; and
setting, in accordance with an output of the machine learning model, a detection result to indicate one of the following: the elevator operates properly, the elevator malfunctions.

14. The method of claim 13, wherein the input data is obtained by obtaining at least one parameter indicative of an operation of the elevator.

15. The method of claim 13, wherein the detection result indicating that the elevator operates properly further comprises data indicative of an expected lifetime of the elevator.

16. A computing system for generating a machine learning model for evaluating a condition of an elevator, the computing system configured to:
generate synthetic data descriptive of an operation of the elevator by simulating the operation of the elevator with a simulation model of the elevator;
access history data generated by operating the elevator corresponding to the elevator of the simulation model;
compare the synthetic data with the history data;
generate data descriptive of differences between the synthetic data and the history data;
calibrate the simulation model of the elevator based on the data descriptive of the differences;
generate calibrated synthetic data descriptive of at least one malfunction of the elevator with a calibrated simulation model of the elevator; and
train the machine learning model with a training dataset based on the calibrated synthetic data to generate the machine learning model for evaluating a condition of the elevator.

17. The computing system of claim 16, wherein the computing system is configured to establish the simulation model of the elevator by using a number of elevator specific parameters of the elevator for which the machine learning model is generated.

18. The computing system of claim 16, wherein the computing system is configured to establish an object-oriented dynamic model as the simulation model.

19. The computing system of claim 16, wherein the computing system is configured to access the history data by at least one of: obtaining a number of parameters of the elevator with a number of sensors; obtaining data of a control signal of an entity of the elevator; retrieving stored history data from data storage.

20. The computing system of claim 19, wherein the computing system is configured to obtain the number of parameters of the elevator from at least one of: at least one accelerometer associated to an elevator car; a motor encoder of an elevator door.

21. The computing system of claim 19, wherein the computing system is configured to apply an input current of a door motor as the control signal.

22. The computing system of claim 16, wherein the computing system is configured to perform a calibration of the simulation model of the elevator by adjusting at least one definition of the simulation model of the elevator with information derivable from the history data.

23. The computing system of claim 16, wherein the computing system is configured to generate the calibrated synthetic data descriptive of at least one malfunction of the elevator by:
determining a number of malfunctions typical to the elevator; and
simulating the determined number of malfunctions with the simulation model of the elevator.

24. The computing system of claim 23, wherein the computing system is configured to determine the number of malfunctions typical to the elevator based on at least one of the following: maintenance requests of the elevator, maintenance operations performed to the elevator, troubleshooting reports of the elevator, error signals received from the elevator.

25. The computing system of claim 16, wherein the training dataset is generated from the calibrated synthetic data-descriptive of at least one malfunction of the elevator by generating a number of representations of a predefined type.

26. The computing system of claim 25, wherein the computing system is configured to generate the representations by applying in at least one of: frequency domain, time domain as the predefined type.

27. The computing system of claim 16, wherein the computing system is configured to generate a convolutional neural network, CNN as the machine learning model for evaluating the condition of the elevator.

28. An elevator comprising a computing system for executing a machine learning model generated according to claim 1 for evaluating a condition of the elevator.

29. A computer program embodied on a non-transitory computer readable medium and comprising instructions which, when the program is executed by a computer, cause the computer to carry out the method according to claim 1.
